(19) United States
(12) Patent Application Publication
(10) Pub. No.: US 2023/0387741 A1
(43) Pub. Date: Nov. 30, 2023

(54) Electrical Machine and Method for Operating an Electrical Machine

(71) Applicant: FEAAM GmbH, Neubiberg (DE)

(72) Inventor: Christian ROTH, Feldkirchen (DE)

(73) Assignee: FEAAM GmbH, Neubiberg (DE)

(21) Appl. No.: 18/320,891

(22) Filed: May 19, 2023

(30) Foreign Application Priority Data
May 27, 2022 (DE) 102022113435.0

(51) Int. Cl. H02K 3/28; H02K 1/16

(52) U.S. Cl. CPC H02K 3/28; H02K 1/16

(57) ABSTRACT

An electrical machine is provided, the electrical machine including a stator and a rotor movable relative to the stator, where the stator includes a stator core in which at least six slots are arranged, the stator includes a distributed electrical winding which is at least partially arranged in the slots, the stator includes at least six teeth, one tooth of the stator is formed between two neighboring slots in each case, at least three of the teeth comprise a recess which extends at least partially through the respective tooth, and in operation of the electrical machine, a working wave of the magnetomotive force differs from a fundamental wave of the magnetic flux. In addition, a method for operating an electrical machine is provided.

### BACKGROUND

An electrical machine and a method for operating an electrical machine are provided.

Typically, electrical machines comprise a stator and a rotor which is movable relative to the stator. Electrical machines may operate as a motor or as a generator, converting electrical energy into kinetic energy or vice versa. In operation, a magnetic field of the rotor interacts with a magnetic field of the stator. The stator typically has a stator winding and an iron core. For example, the stator winding may be formed by distributed overlapping windings or by tooth-concentrated windings. In both cases, higher harmonic components of the magnetomotive force may impair the operation of the electrical machine.

One problem to be solved is to provide an electrical machine that can be operated efficiently. Another problem to be solved is to provide a method for efficiently operating an electrical machine.

### SUMMARY

The problems are solved by the subject-matter of the independent claims. Advantageous embodiments and further developments are specified in the subclaims.

According to at least one embodiment of the electrical machine, the electrical machine includes a stator and a rotor which is movable relative to the stator. The rotor may be an internal rotor or an external rotor. If the rotor is an internal rotor, an outer side of the rotor faces the stator. The rotor can be arranged on a shaft. If the rotor is an external rotor, an inner side of the rotor faces the stator. In addition, the rotor has an axis of rotation. The stator may have the shape of a hollow cylinder. An air gap is arranged between the stator and the rotor. The air gap may extend between the stator and the rotor in a direction which is parallel to the axis of rotation of the rotor.

According to at least one embodiment of the electrical machine, the stator includes a stator core in which at least six slots are arranged. The stator core may comprise iron. The slots may each extend through the stator core. The slots may extend through the stator along the axis of rotation of the rotor. The slots may extend from a first side of the stator to a second side of the stator. Thus, the slots may extend completely through the stator core. The slots may also extend completely through the stator. The slots may each be open toward the air gap. The slots may be recesses in the stator core.

According to at least one embodiment of the electrical machine, the stator includes a distributed electrical winding which is at least partially arranged in the slots. The electrical winding may be a single-layer winding. The electrical winding may comprise at least three coils. Conductors from different coils can overlap in places on the first side. Thus, the electrical winding is not a tooth-concentrated or concentrated winding. Instead, each coil of the electrical winding may extend in at least two slots in places. The electrical winding may comprise an electrically conductive material. The electrical winding may be connected to power electronics and designed to generate a rotating field.

According to at least one embodiment of the electrical machine, the stator comprises at least six teeth. The stator core may comprise the teeth. The teeth may thus be formed from the stator core. The teeth may each extend through the stator along the axis of rotation of the rotor. The teeth may extend completely through the stator. The teeth may extend from the first side of the stator to the second side of the stator. The teeth may comprise the same material as the stator core. The stator may have at least ten teeth or at least fourteen teeth.

According to at least one embodiment of the electrical machine, one tooth of the stator is formed between two neighboring slots in each case. Each tooth may be formed by the region of the stator core between two slots each. The teeth can be uniformly distributed along the circumference of the stator. The slots can be uniformly distributed along the circumference of the stator. The stator can have as many teeth as slots.

According to at least one embodiment of the electrical machine, at least three of the teeth comprise a recess which extends at least partially through the respective tooth. The recesses may each be devoid of the material of the stator core. The recesses can thus be devoid of any material carrying a magnetic flux. This inhibits the magnetic flux in the area of the recesses. The recesses may each be arranged between two slots each. The recesses may each be designed as an additional slot in the stator. At least one tooth of the stator is devoid of the recesses. This can mean that no recess is arranged in at least one tooth of the stator. It is further possible that half of the teeth of the stator is devoid of the recesses.

According to at least one embodiment of the electrical machine, in operation of the electrical machine a working wave of the magnetomotive force differs from a fundamental wave of the magnetic flux. The working wave is the harmonic component of the magnetomotive force which is mainly used for torque generation. The harmonic components of the magnetomotive force are obtained, for example, if the magnetomotive force is split into its harmonic components, e.g., by means of a Fourier decomposition. In so doing, the fundamental wave is the harmonic component of order 1. Thus, in the operation of the electrical machine, a harmonic component of the magnetomotive force with an order different from 1 is used for torque generation. The order of the harmonic component, which is used as working wave, can be larger than 1.

According to at least one embodiment of the electrical machine, the electrical machine comprises a stator, and a rotor which is movable relative to the stator, wherein the stator includes a stator core in which at least six slots are arranged, the stator includes a distributed electrical winding arranged at least partially in the slots, the stator includes at least six teeth, one tooth of the stator is formed between two neighboring slots in each case, at least three of the teeth have a recess extending at least partially through the respective tooth, and in operation of the electrical machine a working wave of the magnetomotive force differs from a fundamental wave of the magnetic flux.

A non-magnetic material can be arranged in the recesses in the stator. For example, air is arranged in the recesses. Thus, the recesses act as flux barriers in the stator. This can mean that the recesses each form a mechanical barrier to reduce the fundamental wave of the magnetic flux. Depending on the design of the electrical machine, the fundamental wave can be weakened by over 90% by using recesses in the stator. At the same time, the working wave can be boosted. This can mean that the fundamental wave of the magnetomotive force for a stator with flux barriers is reduced compared to the fundamental wave of the magnetomotive force for a stator without flux barriers. Furthermore, for at least one harmonic component of the magnetomotive force with an order greater than 1 for a stator with flux barriers, the amplitude may be increased compared to the harmonic component of the magnetomotive force with the same order for a stator without flux barriers.

The harmonic component with the largest amplitude can be used as the working wave. Thus, compared to a stator without any recesses, the amplitude of at least some of the harmonic components of the magnetomotive force, which are not used as working wave, is reduced in the stator having recesses compared to a stator without any recesses. Therefore, less losses occur in operation of the electrical machine. This means that the electrical machine can be operated efficiently.

How much the amplitude of the fundamental wave is reduced and how much the amplitude of harmonic components with an order greater than 1 are increased depends on the design of the stator.

It is further possible for the electrical machine to have a winding factor greater than 1 for a harmonic component of the magnetomotive force with an order greater than 1. The winding factor may be given by the product of the zoning factor and the pitch factor. In electrical machines without recesses or flux barriers, the winding factor is at most 1. If the recesses in the stator are also included in the calculation of the winding factor, the electrical machine described here will have a winding factor of greater than 1 for some harmonic components of the magnetomotive force with an order greater than 1. With a winding factor of greater than 1, a greater torque can be generated in sum with the same supply current. This means that the electrical machine can be operated efficiently.

The formation of the recesses in the stator does not require any significant additional effort in production, since the laminated sheets of the stator are usually stamped parts anyway and the recesses can be punched out in the same work step.

According to at least one embodiment of the electrical machine, the electrical winding comprises coils which are each wound around at least two of the teeth. This may mean that each coil of the electrical winding is wound around at least two of the teeth. Thus, the electrical winding is a distributed winding. The electrical winding may have at least three coils. On the first side and/or on the second side of the stator, individual conductor portions of the coils may overlap one another. By machining the recesses into the stator, the flux density of harmonic components of the magnetomotive force with an order greater than 1 can be amplified for the distributed electrical winding.

According to at least one embodiment of the electrical machine, the recesses are devoid of the electrical winding. This may mean that the electrical winding is not arranged in the recesses. The recesses may be devoid of electrically conductive material. The fact that the recesses are devoid of the electrical winding allows the recesses to act as flow barriers.

According to at least one embodiment of the electrical machine, the recesses each extend in a radial direction, the radial directions each extending parallel to a radius in a cross-section through the stator and the radius extends through the respective tooth. The recesses may each have an elongated extension along a radial direction. Each recess may extend along a different radial direction than the other recesses. The recesses may each extend completely through the stator in one of the radial directions. It is also possible that at least one connecting piece is arranged in each recess, so that the recesses have at least one interruption along the respective radial directions. By having the recesses extend along the radial directions, the recesses can separate two slots from each other in each case. This may mean that the recesses each extend between two slots. This allows the recesses to act as flow barriers.

According to at least one embodiment of the electrical machine, the recesses extend further along the respective radial direction than the neighboring slots. This may mean that each recess extends along the radial direction along which it extends further than the two slots directly neighboring the respective recess. Thus, in a cross-section through the stator, the recesses may each have a longer extension than the slots. The recesses may extend from an outer side of the stator towards an inner side of the stator. Here, the recesses can each extend along a radial direction in one of the teeth to a region of the respective tooth that is neighboring the rotor. By extending further than the neighboring slots, the recesses separate two slots from each other in each case. Thus, the recesses can act as flow barriers.

According to at least one embodiment of the electrical machine, the recesses are formed such that a harmonic component of the magnetomotive force, which is used as a working wave, has a larger amplitude than a harmonic component of the magnetomotive force of the same order of an electrical machine without recesses. This may mean that the recesses cause the amplitude of a harmonic component of the magnetomotive force used as a working wave to be increased compared to the case where the electrical machine has no recesses. Thus, the electrical machine can be operated more efficiently.

According to at least one embodiment of the electrical machine, the electrical machine is not a stepper motor.

According to at least one embodiment of the electrical machine, each of the recesses forms a mechanical barrier in order to reduce the fundamental wave of the magnetic flux and increase the working wave of the magnetomotive force. The electrical machine can thus be operated more efficiently.

According to at least one embodiment of the electrical machine, the recesses extend along a direction that is perpendicular to a cross-section through the stator. This may mean that the recesses extend along a direction that is parallel to the axis of rotation of the rotor. Thus, the recesses may extend from the first side of the stator to the second side of the stator. The recesses may extend from the first side completely to the second side of the stator. It is also possible that at least one connecting web is arranged in each of the recesses along the distance from the first side to the second side. This can increase the mechanical stability of the stator. By extending in a direction perpendicular to the cross-section through the stator, the recesses can act as flow barriers.

According to at least one embodiment of the electrical machine, a non-magnetic material is arranged in each of the recesses. The non-magnetic material can completely fill the recesses in each case. For example, air is arranged in the recesses. Due to the fact that a non-magnetic material is arranged in the recesses, the recesses can act as flow barriers.

According to at least one embodiment of the electrical machine, the recesses are uniformly distributed along the circumference of the stator. This may mean that any two directly neighboring recesses are equally spaced along the circumference of the stator. Thus, the recesses can act as flux barriers in the same way for different poles of the stator.

According to at least one embodiment of the electrical machine, the recesses are each adjacent to at least an outer side of the stator. It is possible that the recesses are adjacent to an outer side of the stator arranged at the outer circumference of the stator. The recesses may be open towards the outer side of the stator. It is also possible that the recesses are adjacent to an inner side of the stator. The recesses can be open toward the inner side of the stator. Thus, the recesses can act as flow barriers.

According to at least one embodiment of the electrical machine, every other tooth along the circumference of the stator comprises one of the recesses. This may mean that every other tooth along the circumference of the stator has exactly one of the recesses. This design of the stator may result in the flux density of the fundamental wave being substantially reduced and the flux density of at least one harmonic component having an order greater than 1 being substantially increased.

According to at least one embodiment of the electrical machine, each tooth has one of the recesses. This may mean that exactly one of the recesses is arranged in each tooth. This design can lead to a higher reduction of the flux density of the fundamental wave than in the case that only every other tooth has one of the recesses. Furthermore, an increase of the flux density of at least one harmonic component with the order greater than 1 is possible.

According to at least one embodiment of the electrical machine, the stator has at most as many recesses as slots. Thus, one recess can be arranged between each two slots. This design of the stator may have the effect that the flux density of the fundamental wave is substantially reduced and the flux density of at least one harmonic component with an order of greater than 1 is substantially increased.

According to at least one embodiment of the electrical machine, the stator has more than six teeth. For example, the stator has at least ten teeth or at least 14 teeth. With a larger number of teeth, the stator may have a larger number of magnetic poles.

According to at least one embodiment of the electrical machine, at least two components of the electrical winding are arranged in each slot, which are designed to be supplied with different phase currents. For example, conductor portions of two different coils of the electrical winding may be arranged in a slot. Thus, at least two conductor portions of different coils of the electrical winding may be arranged in each slot. Within each slot, the conductor portions of the different coils may be electrically isolated from one another. Thus, the slots may have a two-layer or multilayer design.

A method for operating an electrical machine is also provided. The electrical machine may be operated by the method. All features of the described electrical machine are also disclosed for the method for operating an electrical machine and vice versa.

According to at least one embodiment of the method for operating an electrical machine, the method comprises operating the electrical machine with a working wave of the magnetomotive force, the working wave differing from a fundamental wave of the magnetic flux. The fact that the electrical machine is operated may mean that a torque is generated with the electrical machine. Thus, the electrical machine is operated in such a way that a working wave is used for torque generation, which differs from a fundamental wave of the magnetic flux.

According to at least one embodiment of the method, the electrical machine comprises a stator comprising a stator core in which at least six slots are arranged, a distributed electrical winding which is at least partially arranged in the slots, and at least six teeth, the electrical machine comprising a rotor which is movable relative to the stator, one tooth of the stator being formed between two adjacent slots in each case, and at least three of the teeth comprising a recess which extends at least partially through the respective tooth.

The method has the same advantages as the electrical machine. Thus, the method allows the electrical machine to be operated efficiently.

According to at least one embodiment of the method, a harmonic of the magnetomotive force is used as a working wave, the harmonic comprising an order equal to the number of slots plus 1 or the number of slots minus 1. This can mean that the number of slots of the stator added with 1 results in the order of the harmonic component of the magnetomotive force, which is used as working wave. It is also possible that the number of slots of the stator minus 1 is equal to the order of the harmonic component of the magnetomotive force, which is used as the working wave. Thus, in both cases, the working wave that is used is a harmonic component of the magnetomotive force that has an order greater than 1. With these two possibilities of the order of the harmonic component, which is used as working wave, the increase of the flux density and of the winding factor is highest due to the fact that the recesses are arranged in the stator. Thus, the harmonic components with these two order numbers are suitable for efficient torque generation.

It is also possible that the design of the electrical winding is repeated n times along the circumference of the stator, where n is a natural number. In this case, a harmonic of the magnetomotive force having an order of the number of slots plus n or the number of slots minus n is used as the working wave.

A further electrical machine is provided. Each electrical machine described here solves the problem to be solved. All the same features or identically designated features of the electrical machines described herein are in each case also disclosed for the other electrical machines, and vice versa.

According to at least one embodiment of the electrical machine, the electrical machine includes a stator, and a rotor which is movable relative to the stator.

According to at least one embodiment of the electrical machine, the stator includes a stator core in which at least three slots are arranged.

According to at least one embodiment of the electrical machine, the stator includes at least three teeth and at least three rod-shaped electrical conductors. The electrical conductors may each have the shape of a rod. The electrical conductors may comprise an electrically conductive material, for example copper or aluminum. The electrical conductors may each extend through the stator parallel to the axis of rotation of the rotor. The electrical conductors may be dimensionally stable, which may mean that they are not bendable. The electrical conductors may be designed to be supplied with a separate electrical phase in each case. For this purpose, each electrical conductor may be separately connected to power electronics.

According to at least one embodiment of the electrical machine, at least one of the conductors is arranged in each of the slots. One of the conductors may be arranged in each slot.

According to at least one embodiment of the electrical machine, one tooth of the stator is formed between two neighboring slots in each case.

According to at least one embodiment of the electrical machine, at least three of the teeth comprise a recess which extends at least partially through the respective tooth.

According to at least one embodiment of the electrical machine, in operation of the electrical machine a working wave of the magnetomotive force differs from a fundamental wave of the magnetic flux.

According to at least one embodiment of the electrical machine, the electrical machine includes a stator, and a rotor which is movable relative to the stator, the stator comprising a stator core in which at least three slots are arranged, the stator comprising at least three teeth and at least three rod-shaped electrical conductors, at least one of the conductors being arranged in each of the slots, one tooth of the stator being formed between two neighboring slots in each case, at least three of the teeth having a recess which extends at least partially through the respective tooth, in operation of the electrical machine a working wave of the magnetomotive force differing from a fundamental wave of the magnetic flux.

The electrical machine has the advantages described above. Instead of a distributed electrical winding, the electrically conductive rods are used here. Also in this design, the arrangement of recesses in the stator results in the flux density of the fundamental wave being reduced compared to the situation where no recesses are arranged in the stator. In addition, the flux density for at least one harmonic component of the magnetomotive force with an order greater than 1 may be increased in the case where the stator has recesses compared to the case where the stator has no recesses.

According to at least one embodiment of the electrical machine, the three conductors are electrically short-circuited on one side of the stator. The three conductors can be electrically short-circuited on the first side of the stator. For this purpose, a short-circuit ring can be arranged on the first side of the stator. The short-circuit ring may comprise an electrically conductive material. The conductors can be electrically conductively connected to the short-circuit ring. On the second side of the stator, the conductors can be connected to power electronics. Thus, the conductors may each be supplied with a separate electrical phase.

A further method for operating an electrical machine is also provided. The further electrical machine can be operated with the further method. All of the same features or identically designated features of the electrical machines and methods described herein are respectively also disclosed for the further electrical machines and methods, and vice versa.

According to at least one embodiment of the method for operating an electrical machine, the method includes operating the electrical machine with a working wave of the magnetomotive force, the working wave differing from a fundamental wave of the magnetic flux.

According to at least one embodiment of the method for operating an electrical machine, the electrical machine comprises a stator comprising a stator core in which at least three slots are arranged, at least three teeth, and at least three rod-shaped electrical conductors, the electrical machine comprises a rotor which is movable relative to the stator, at least one of the conductors is arranged in the slots in each case, one tooth of the stator is formed between two adjacent slots in each case, and at least three of the teeth comprise a recess which extends at least partially through the respective tooth.

The method has the same advantages as the electrical machine. Thus, the method allows the electrical machine to be operated efficiently.

In the following, the electrical machine and the method for operating an electrical machine are explained in more detail in connection with exemplary embodiments and the associated Figures.

### BRIEF DESCRIPTION OF THE DRAWINGS

Figures LA, 1B, 1C, 1D and 1E illustrate an exemplary embodiment of the electrical machine. In addition, an exemplary embodiment of the method for operating an electrical machine is described.

FIGS. 2A, 2B, 2C, 2D and 2E illustrate a further exemplary embodiment of the electrical machine.

FIGS. 3A, 3B, 3C, 3D and 3E illustrate a further exemplary embodiment of the electrical machine.

FIGS. 4A, 4B, 4C, 4D and 4E illustrate a further exemplary embodiment of the electrical machine.

FIGS. 5A, 5B, 5C, 5D and 5E illustrate a further exemplary embodiment of the electrical machine.

FIGS. 6A, 6B, 6C, 6D and 6E illustrate a further exemplary embodiment of the electrical machine.

FIGS. 7A, 7B, 7C, 7D and 7E illustrate a further exemplary embodiment of the electrical machine.

FIGS. 8A, 8B, 8C, 8D, 8E, 8F and 8G illustrate a further exemplary embodiment of the electrical machine.

FIGS. 9A, 9B, 9C, 9D and 9E illustrate a further exemplary embodiment of the electrical machine.

FIGS. 10A, 10B, 10C, 10D and 10E illustrate a further exemplary embodiment of the electrical machine.

With FIGS. 11A, 11B, 11C, 11D and 11E illustrate a further exemplary embodiment of the electrical machine.

### DETAILED DESCRIPTION

FIG. 1A shows a cross-sectional view of an electrical machine 20 according to an exemplary embodiment. The electrical machine 20 includes a stator 21 and a rotor 22 movable relative to the stator 21. The rotor 22 is disposed within the stator 21. The cross-section shown in FIG. 1A extends in a plane perpendicular to the axis of rotation of the rotor 22.

The stator 21 has a stator core 23 in which six slots 24 are arranged. An air gap 34 is arranged between the stator 21 and the rotor 22. The slots 24 are each open toward the air gap 34. The stator 21 further comprises a distributed winding which is at least partially arranged in the slots 24. The distributed winding 25 may comprise at least three coils 28. Further, the stator 21 has six teeth 26, with one tooth 26 formed between two neighboring slots 24 in each case. The distributed winding 25 is distinguished in that the coils 28 of the winding 25 are not each wound around only one tooth 26. In the exemplary embodiment in FIG. 1A, conductor portions of the same coil 28 of the electrical winding 25 are arranged in a total of two different slots 24. Each coil 28 may be composed of a plurality of conductor portions 35. Thus, the coils 28 are each wound around at least two of the teeth 26. In FIG. 1A, the letters in the slots 24 each indicate the same phase. The plus signs and minus signs indicate the direction of electric current through the respective conductor portions 35 in operation of the electrical machine 20. Thus, in operation of the electrical machine 20, the current flows in the same direction in all conductor portions 35 which are labeled plus. In the conductor portions 35, which are labeled minus, the current flows in the opposite direction in operation of the electrical machine 20.

The teeth 26 each have a recess 27 extending through the respective tooth 26. The recesses 27 are devoid of the electrical winding 25. It is also possible that at least one connecting piece is arranged in each recess 27. Such connecting pieces are not shown in the Figures.

The recesses 27 each extend in a radial direction r, the radial directions r each being parallel to a radius in cross-section through the stator 21 and the radius extending through the respective tooth 26. Along the respective radial direction r, the recesses 27 extend further than the neighboring slots 24. A non-magnetic material 29, for example air, is arranged in each of the recesses 27. The recesses 27 each adjoin an outer side 30 and an inner side 33 of the stator 21. However, it is also possible that the recesses 27 extend less far along the radial directions r than shown in FIG. 1A. The recesses 27, the slots 24 and the teeth 26 are all uniformly distributed along the circumference of the stator 21. The stator 21 has as many recesses 27 as slots 24.

In operation of the electrical machine 20, a working wave of the magnetomotive force differs from a fundamental wave of the magnetic flux. Thus, according to one exemplary embodiment of the method for operating an electrical machine 20, the electrical machine 20 is operated with a working wave of the magnetomotive force that differs from a fundamental wave of the magnetic flux.

In FIG. 1B, the design of FIG. 1A is shown without the recesses 27 for comparison.

In FIG. 1C, the flux density in the air gap 34 of the electrical machine 20 is plotted. The angle along the air gap 34 is plotted on the x-axis. The flux density is plotted on the y-axis. Here, the dashed line refers to the design shown in FIG. 1B. The solid line refers to the exemplary embodiment of the electrical machine 20 shown in FIG. 1A.

FIG. 1D shows a plot of the flux density in the air gap 34 of the electrical machine 20 broken down by harmonic components. The order of the harmonic components of the magnetomotive force is plotted on the x-axis. The flux density is plotted on the y-axis. The filled bars refer to the design shown in FIG. 1B. The empty bars refer to the exemplary embodiment shown in FIG. 1A. FIG. 1D thus shows that the flux density of the fundamental wave for the exemplary embodiment in FIG. 1A is significantly reduced, namely by 72%, compared to the case where the electrical machine 20 has no recesses 27. The percentage by which the flux density is increased or decreased in each case is indicated in FIG. 1D next to the corresponding bars. In addition, for the harmonic components of orders 5 and 7 for the exemplary embodiment of FIG. 1A, the flux density is increased by 72% compared to the case where the electrical machine 20 has no recesses 27.

The exemplary embodiment of Figure LA thus allows to use as working wave a harmonic component of the magnetomotive force the order of which differs from 1. In this case it is suitable to use as working wave a harmonic of the magnetomotive force, which has an order of 5 or 7. This means that as working wave a harmonic of the magnetomotive force is used, which has an order equal to the number of slots 24 plus 1 or the number of slots 24 minus 1.

In FIG. 1E, the winding factor of the electrical machine 20 from Figure LA is plotted. The order of the harmonic component of the magnetomotive force is plotted on the x-axis. On the y-axis, the equivalent winding factor is plotted. In the calculation of the winding factor, the recesses 27 were also taken into account. Thus, the winding factor for the harmonics of orders 5 and 7 is well above 1, namely about 1.7. This means that the calculation of the winding factor also shows that the electrical machine 20 of FIG. 1A can be operated efficiently with a working wave which is a harmonic component of order 5 or 7 of the magnetomotive force.

Here and in the following exemplary embodiments, the electrical machine 20 may have a rotor 22 with permanent magnets and a number of pole pairs, the number of pole pairs corresponding to the order of the harmonic component used as the working wave.

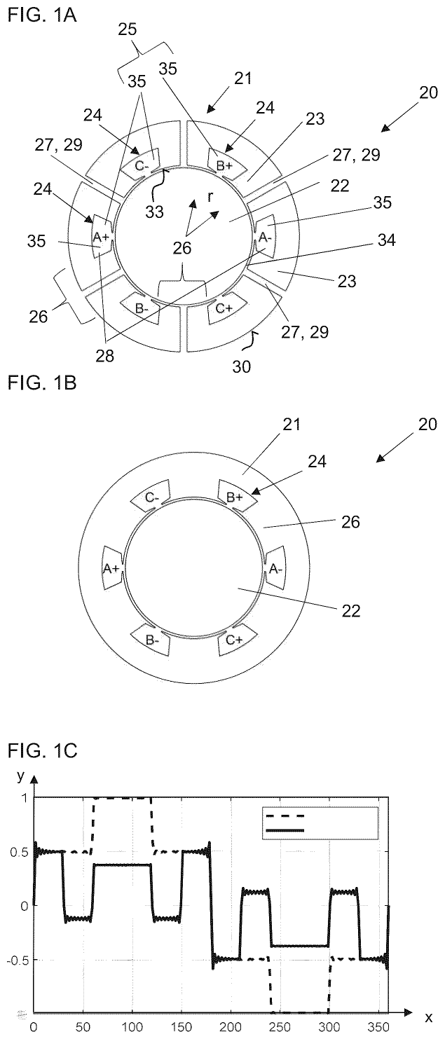

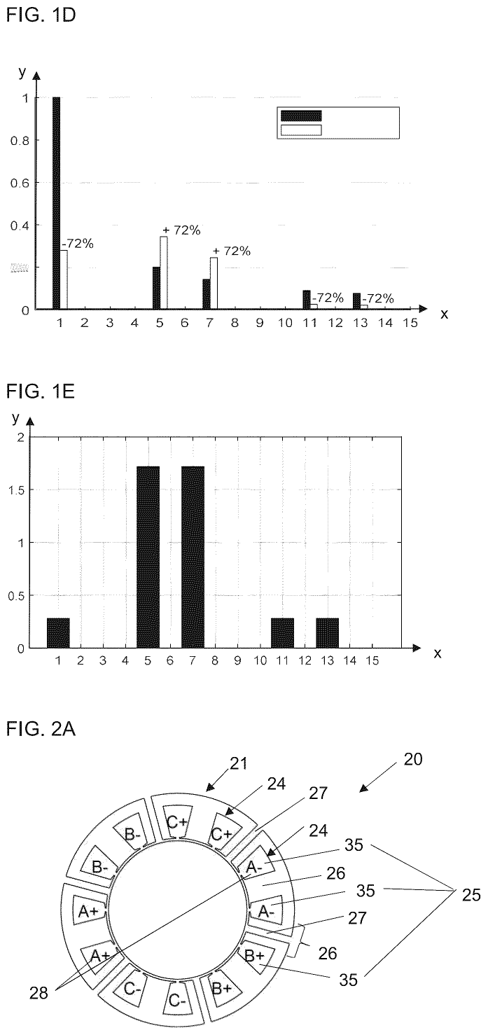

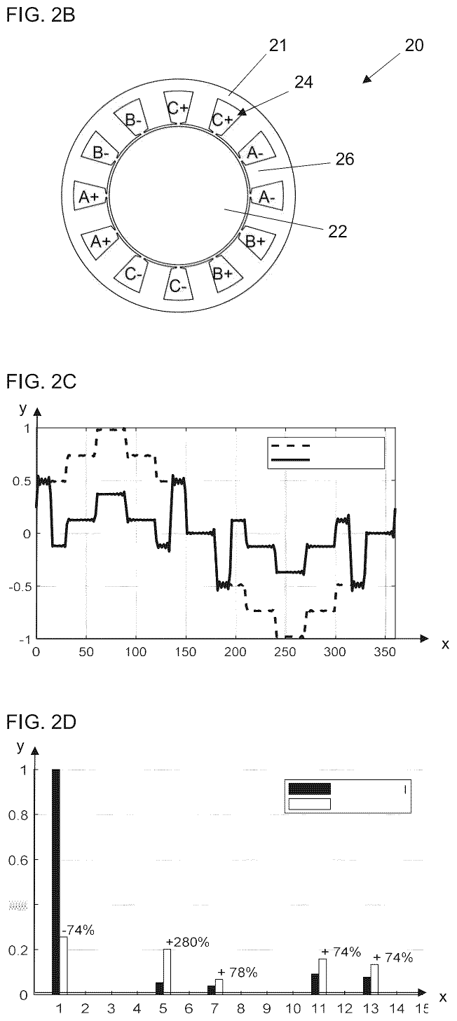

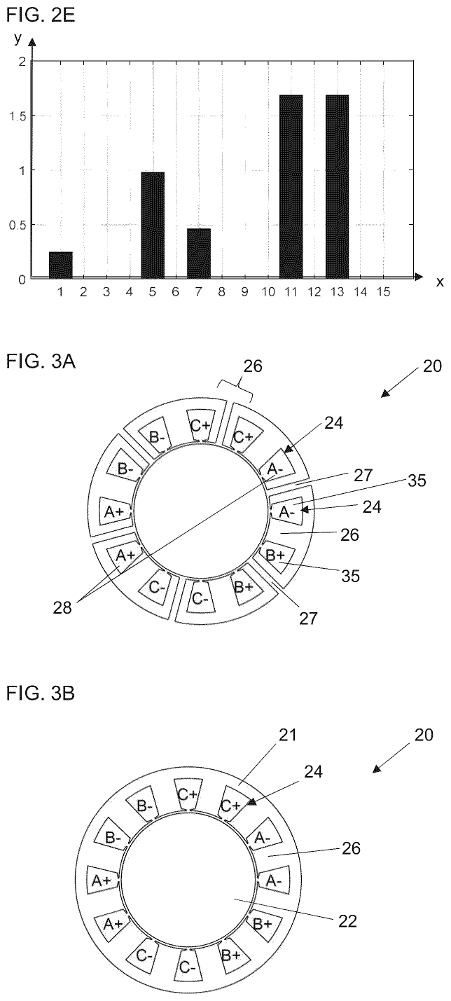

FIG. 2A shows a further exemplary embodiment of the electrical machine 20. Unlike the exemplary embodiment shown in Figure LA, the stator 21 of the exemplary embodiment of FIG. 2A has a total of twelve slots 24 and twelve teeth 26. The electrical winding 25 is distributed over the twelve slots 24. The electrical winding 25 has two coils 28 for each phase, i.e., two for phase A, two for phase B, and two for phase C. Here, two conductor portions 35 of each phase, in which current flows in the same direction during operation, are arranged next to each other along the circumference of the stator 21. The stator 21 has a total of six recesses 27. Thus, every other tooth 26 along the circumference of the stator 21 has a recess 27. The conductor portions 35 are labeled in the same manner as in Figure LA.

The recesses 27 are each arranged in the teeth 26, which are located between two slots 24, in which conductor portions 35 of two coils 28 of different phases are arranged. The teeth 26, which are located between two slots 24, in which conductor portions 35 of the same phase are arranged, are devoid of recesses 27.

In FIG. 2B, the design of FIG. 2A is shown without the recesses 27 for comparison.

In FIG. 2C, the flux density in the air gap 34 of the electrical machine 20 is plotted. The angle along the air gap 34 is plotted on the x-axis. The flux density is plotted on the y-axis. Here, the dashed line refers to the design shown in FIG. 2B. The solid line refers to the exemplary embodiment of the electrical machine 20 from FIG. 2A.

In FIG. 2D, the flux density in the air gap 34 of the electrical machine 20 is plotted broken down by harmonic components. The order of the harmonic components of the magnetomotive force is plotted on the x-axis. The flux density is plotted on the y-axis. The filled bars refer to the design shown in FIG. 2B. The empty bars refer to the exemplary embodiment shown in FIG. 2A. The fundamental wave is reduced by 74% compared to the case where the electrical machine 20 has no recesses 27. In addition, for the harmonic components of orders 5, 7, 11 and 13, the flux density is increased for the exemplary embodiment shown in FIG. 2A compared to the case where the electrical machine 20 has no recesses 27.

In FIG. 2E, the winding factor of the electrical machine 20 from FIG. 2A is plotted. The order of the harmonic component of the magnetomotive force is plotted on the x-axis. On the y-axis, the equivalent winding factor is plotted. Thus, for the harmonics of orders 11 and 13, the winding factor is well above 1, namely about 1.7. For the exemplary embodiment of FIG. 2A, the harmonic component of the magnetomotive force of order 11 or 13 can thus be used as a working wave for an efficient operation of the electrical machine 20. This means that a harmonic of the magnetomotive force having an order equal to the number of slots 24 plus 1 or the number of slots 24 minus 1 is also used here as the working wave.

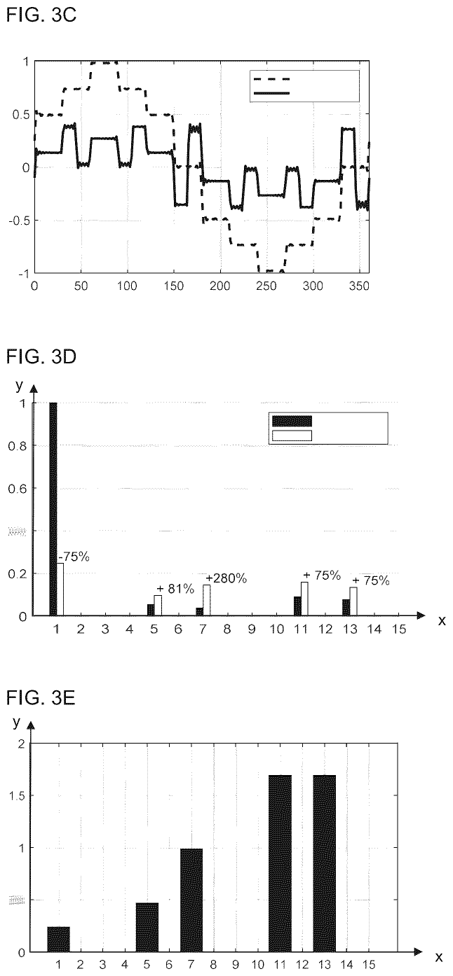

FIG. 3A shows a further exemplary embodiment of the electrical machine 20. In contrast to the exemplary embodiment shown in FIG. 2A, the recesses 27 are each arranged in the teeth 26 which are arranged between two slots 24 in which conductor portions 35 of the same phase are arranged. The teeth 26, which are located between two slots 24 in which conductor portions 35 of coils 28 of two different phases are arranged, are devoid of recesses 27.

In FIG. 3B, the design of FIG. 3A is shown without the recesses 27 for comparison.

In FIG. 3C, the flux density in the air gap 34 of the electrical machine 20 is plotted. On the x-axis, the angle along the air gap 34 is plotted. On the y-axis, the flux density is plotted. Here, the dashed line refers to the design shown in FIG. 3B. The solid line refers to the exemplary embodiment of the electrical machine 20 shown in FIG. 3A.

FIG. 3D shows a plot of the flux density in the air gap 34 of the electrical machine 20 broken down by harmonic components. On the x-axis, the order of the harmonic components of the magnetomotive force is plotted. The flux density is plotted on the y-axis. The filled bars refer to the design shown in FIG. 3B. The empty bars refer to the exemplary embodiment shown in FIG. 3A. The fundamental wave is reduced by 75% compared to the case where the electrical machine 20 has no recesses 27. In addition, for the harmonic components of orders 5, 7, 11 and 13, the flux density is increased for the exemplary embodiment shown in FIG. 3A compared to the case where the electrical machine 20 has no recesses 27.

FIG. 3E shows a plot of the winding factor of the electrical machine 20 from FIG. 3A. The order of the harmonic component of the magnetomotive force is plotted on the x-axis. On the y-axis, the equivalent winding factor is plotted. Thus, for the harmonics of orders 11 and 13, the winding factor is well above 1, namely about 1.7. For the exemplary embodiment of FIG. 3A, the harmonic component of the magnetomotive force of order 11 or 13 can thus be used as a working wave for an efficient operation of the electrical machine 20.

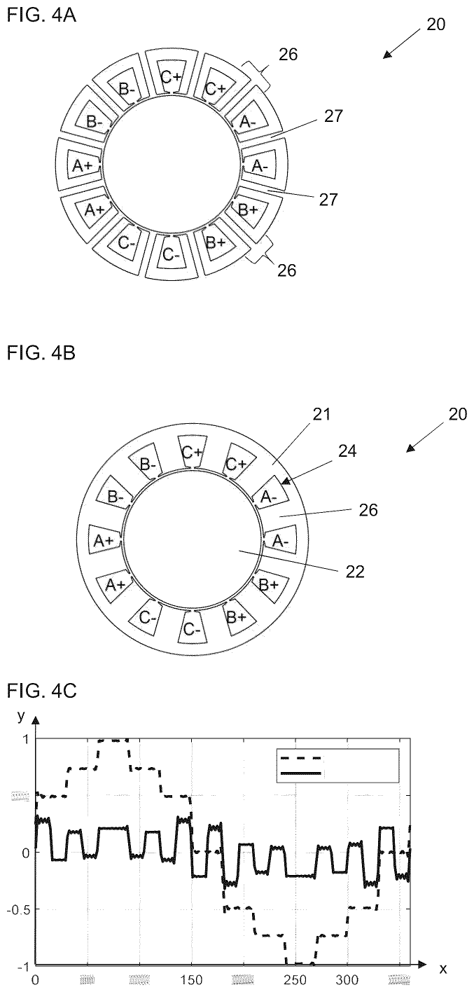

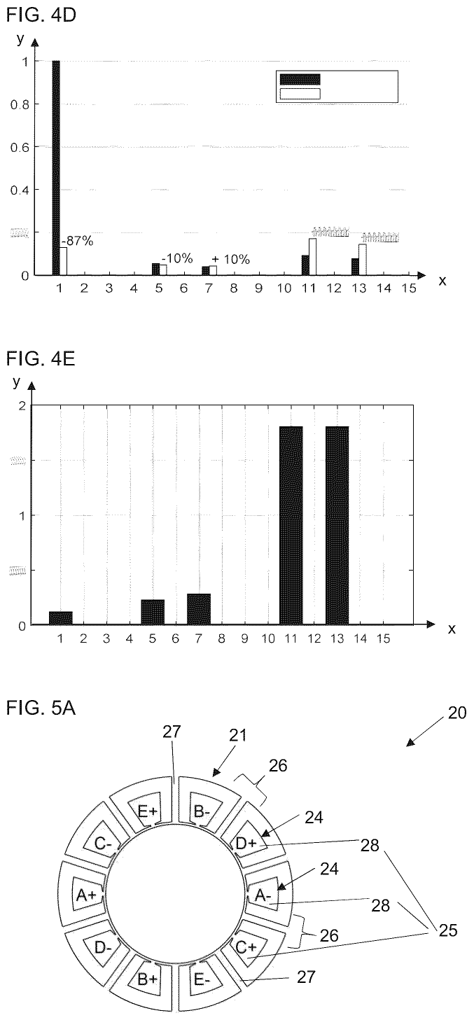

FIG. 4A shows a further exemplary embodiment of the electrical machine 20. Unlike the exemplary embodiment shown in FIG. 2A, each tooth 26 has a recess 27.

In FIG. 4B, the design of FIG. 4A is shown without the recesses 27 for comparison.

FIG. 4C shows a plot of the flux density in the air gap 34 of the electrical machine 20. On the x-axis, the angle along the air gap 34 is plotted. On the y-axis, the flux density is plotted. Here, the dashed line refers to the design shown in FIG. 4B. The solid line refers to the exemplary embodiment of the electrical machine 20 shown in FIG. 4A.

In FIG. 4D, the flux density in the air gap 34 of the electrical machine 20 is plotted broken down by harmonic components. On the x-axis, the order of the harmonic components of the magnetomotive force is plotted. The flux density is plotted on the y-axis. The filled bars refer to the design shown in FIG. 4B. The empty bars refer to the exemplary embodiment shown in FIG. 4A. The fundamental wave is reduced by 87% compared to the case where the electrical machine 20 has no recesses 27. Furthermore, for the harmonic components of orders 5, 7, 11 and 13, the flux density is increased for the exemplary embodiment shown in FIG. 4A compared to the case where the electrical machine 20 has no recesses 27.

FIG. 4E shows a plot of the winding factor of the electrical machine 20 from FIG. 4A. The order of the harmonic component of the magnetomotive force is plotted on the x-axis. On the y-axis, the equivalent winding factor is plotted. Thus, for the harmonics of orders 11 and 13, the winding factor is well above 1, namely about 1.8. For the exemplary embodiment of FIG. 4A, the harmonic component of the magnetomotive force of order 11 or 13 can thus be used as a working wave for an efficient operation of the electrical machine 20.

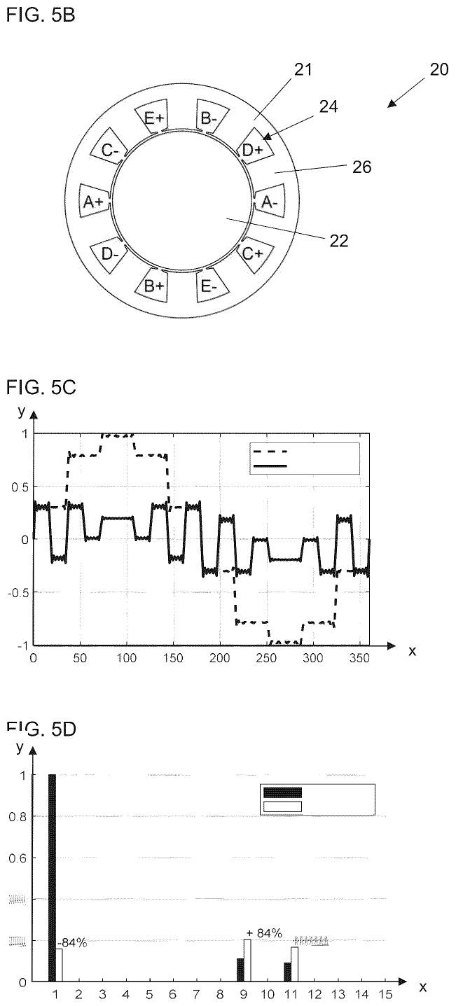

FIG. 5A shows a further exemplary embodiment of the electrical machine 20. Unlike the exemplary embodiment shown in FIG. 2A, the stator 21 has a total of ten slots 24 and ten teeth 26. The electrical winding 25 has five coils 28. Each coil 28 has a phase associated to it, which phases are marked with the letters in FIG. 5A. That is, each coil 28 is designed to be supplied with its own phase current. The stator 21 also has a recess 27 in each tooth 26. Thus, the stator 21 has ten recesses 27.

FIG. 5B shows the design of FIG. 5A without the recesses 27 for comparison.

FIG. 5C shows a plot of the flux density in the air gap 34 of the electrical machine 20. On the x-axis, the angle along the air gap 34 is plotted. On the y-axis, the flux density is plotted. Here, the dashed line refers to the design shown in FIG. 5B. The solid line refers to the exemplary embodiment of the electrical machine 20 shown in FIG. 5A.

In FIG. 5D, the flux density in the air gap 34 of the electrical machine 20 is plotted broken down by harmonic components. On the x-axis, the order of the harmonic components of the magnetomotive force is plotted. The flux density is plotted on the y-axis. The filled bars refer to the design shown in FIG. 5B. The empty bars refer to the exemplary embodiment shown in FIG. 5A. The fundamental wave is reduced by 84% compared to the case where the electrical machine 20 has no recesses 27. In addition, for the harmonic components of orders 9 and 11, the flux density is increased for the exemplary embodiment shown in FIG. 5A compared to the case where the electrical machine 20 has no recesses 27.

FIG. 5E shows a plot of the winding factor of the electrical machine 20 from FIG. 5A. To this end, the order of the harmonic component of the magnetomotive force is plotted on the x-axis. On the y-axis, the equivalent winding factor is plotted. Thus, for the harmonics of orders 9 and 11, the winding factor is well above 1, namely about 1.8. For the exemplary embodiment of FIG. 5A, the harmonic component of the magnetomotive force of order 9 or 11 can thus be used as a working wave for an efficient operation of the electrical machine 20.

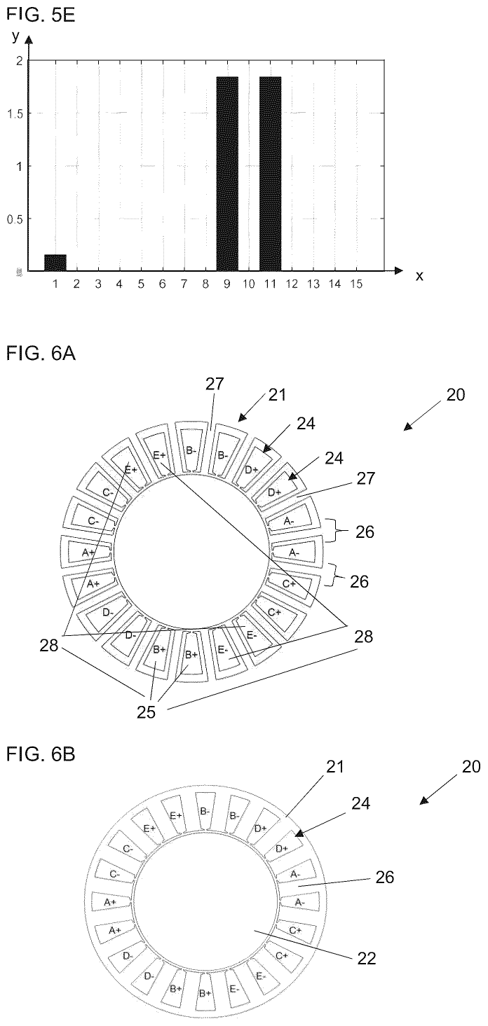

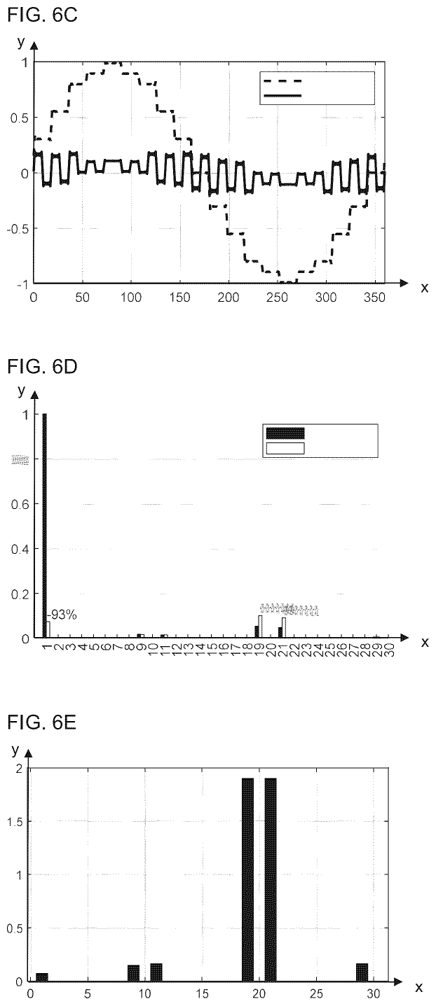

FIG. 6A shows a further exemplary embodiment of the electrical machine 20. Unlike the exemplary embodiment shown in FIG. 5A, the stator 21 has a total of twenty slots 24 and twenty teeth 26. The electrical winding 25 further has five phases, with a total of four slots 24 being provided for each phase. The electrical winding 25 has two coils 28 per phase, i.e., a total of ten coils 28. The stator 21 also has a recess 27 in each tooth 26. Thus, the stator 21 has twenty recesses 27.

For comparison, FIG. 6B shows the design of FIG. 6A without the recesses 27.

FIG. 6C shows a plot of the flux density in the air gap 34 of the electrical machine 20. On the x-axis, the angle along the air gap 34 is plotted. On the y-axis, the flux density is plotted. Here, the dashed line refers to the design shown in FIG. 6B. The solid line refers to the exemplary embodiment of the electrical machine 20 shown in FIG. 6A.

In FIG. 6D, the flux density in the air gap 34 of the electrical machine 20 is plotted broken down by harmonic components. On the x-axis, the order of the harmonic components of the magnetomotive force is plotted. The flux density is plotted on the y-axis. The filled bars refer to the design shown in FIG. 6B. The empty bars refer to the exemplary embodiment shown in FIG. 6A. The fundamental wave is reduced by 93% compared to the case where the electrical machine 20 has no recesses 27. Furthermore, for the harmonic components of orders 19 and 21 for the exemplary embodiment shown in FIG. 6A, the flux density is increased compared to the case where the electrical machine 20 has no recesses 27.

FIG. 6E shows a plot of the winding factor of the electrical machine 20 from FIG. 6A. The order of the harmonic component of the magnetomotive force is plotted on the x-axis. On the y-axis, the equivalent winding factor is plotted. Thus, for the harmonics of orders 19 and 21, the winding factor is well above 1, namely about 1.9. For the exemplary embodiment of FIG. 6A, the harmonic component of the magnetomotive force of order 19 or 21 can thus be used as a working wave for an efficient operation of the electrical machine 20.

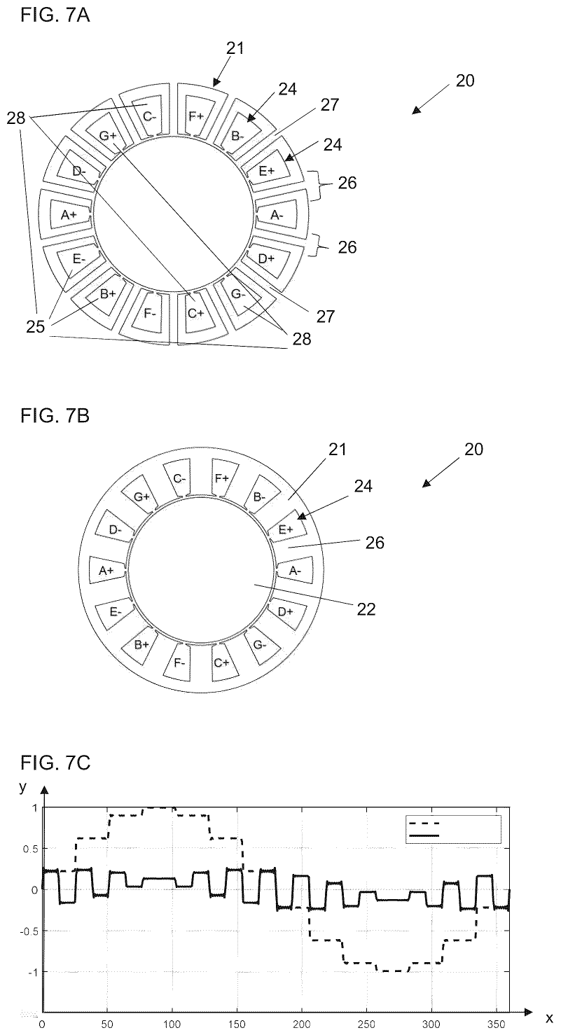

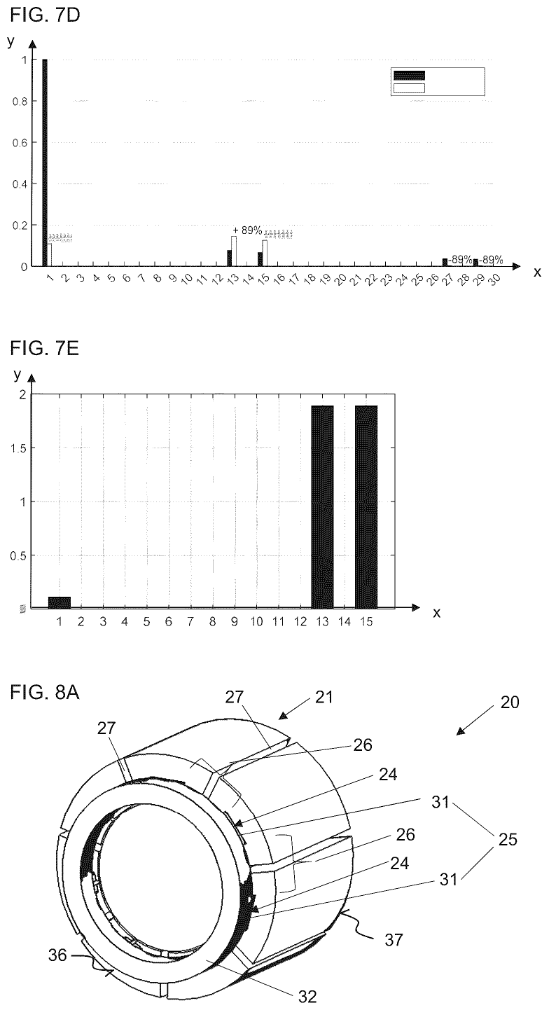

FIG. 7A shows a further exemplary embodiment of the electrical machine 20. Unlike the exemplary embodiment shown in FIG. 5A, the stator 21 has a total of fourteen slots 24 and fourteen teeth 26. The electrical winding 25 has seven phases, with two slots 24 being provided for each phase. The electrical winding 25 has one coil 28 per phase, i.e., a total of seven coils 28. The stator 21 also has a recess 27 in each tooth 26. Thus, the stator 21 has fourteen recesses 27.

For comparison, FIG. 7B shows the design of FIG. 7A without the recesses 27.

FIG. 7C shows a plot of the flux density in the air gap 34 of the electrical machine 20. On the x-axis, the angle along the air gap 34 is plotted. On the y-axis, the flux density is plotted. Here, the dashed line refers to the design shown in FIG. 7B. The solid line refers to the exemplary embodiment of the electrical machine 20 shown in FIG. 7A.

FIG. 7D shows a plot of the flux density in the air gap 34 of the electrical machine 20 broken down by harmonic components. On the x-axis, the order of the harmonic components of the magnetomotive force is plotted. The flux density is plotted on the y-axis. The filled bars refer to the design shown in FIG. 7B. The empty bars refer to the exemplary embodiment shown in FIG. 7A. The fundamental wave is reduced by 89% compared to the case where the electrical machine 20 has no recesses 27. Furthermore, for the harmonic components of orders 13 and 15 for the exemplary embodiment shown in FIG. 7A, the flux density is increased compared to the case where the electrical machine 20 has no recesses 27.

FIG. 7E shows a plot of the winding factor of the electrical machine 20 from FIG. 7A. The order of the harmonic component of the magnetomotive force is plotted on the x-axis. On the y-axis, the equivalent winding factor is plotted. Thus, for the harmonics of orders 13 and 15, the winding factor is well above 1, namely about 1.9. For the exemplary embodiment of FIG. 7A, the harmonic component of the magnetomotive force of order 13 or 15 can thus be used as a working wave for an efficient operation of the electrical machine 20.

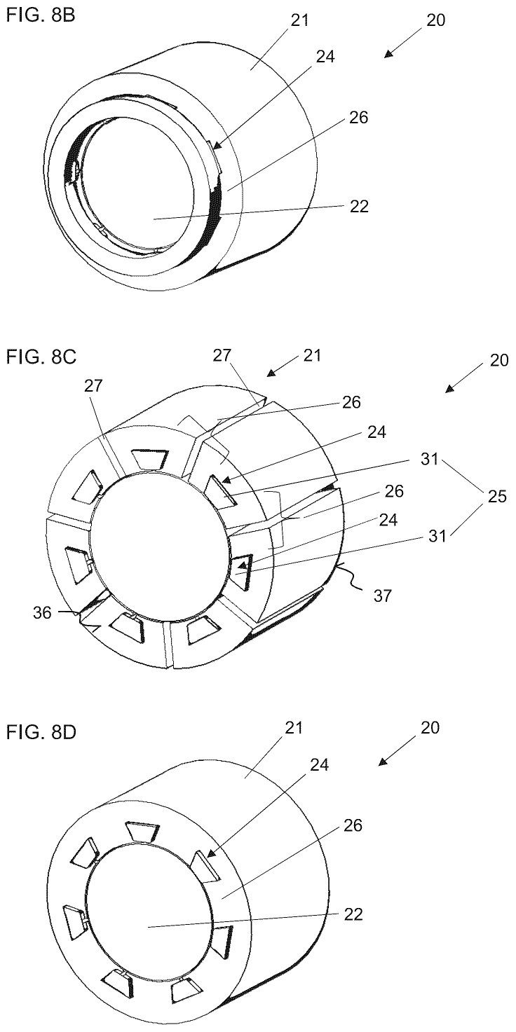

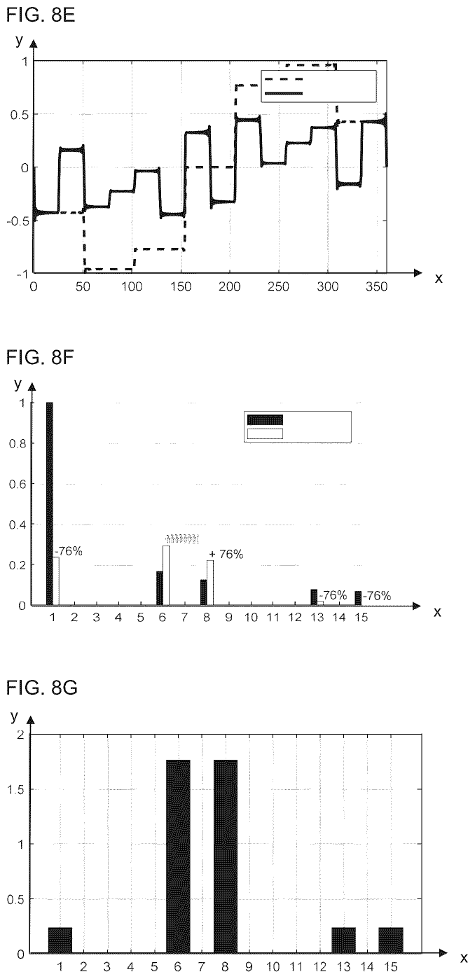

FIG. 8A shows a further exemplary embodiment of the electrical machine 20. Unlike the exemplary embodiment shown in FIG. 1A, the stator 21 has a total of seven slots 24 and seven teeth 26. In addition, the stator 21 has seven rod-shaped electrical conductors 31. One of the conductors 31 is disposed in each of the slots 24. The conductors 31 extend from a first side 36 of the stator 21 to a second side 37 of the stator 21. Thus, the electrical winding 25 does not have any coils 28. Further, the stator 21 comprises seven recesses 27. Here, each tooth 26 has a recess 27.

On the first side 36 of the stator 21, the conductors 31 are electrically short-circuited. For this purpose, the conductors 31 are electrically connected to a short-circuit ring 32, which is arranged on the first side 36 of the stator 21. On the second side 37, the conductors 31 are connected to power electronics so that each conductor 31 can be supplied with its own phase. Thus, the electrical machine 20 has seven phases.

According to one embodiment of the method for operating an electrical machine 20, the electrical machine 20 of FIG. 8A is operated in such a way that a working wave of the magnetomotive force differs from a fundamental wave of the magnetic flux.

In FIG. 8B, the design of FIG. 8A is shown without the recesses 27 for comparison.

In FIG. 8C, the electrical machine 20 of FIG. 8A is shown without the short-circuit ring 32.

In FIG. 8D, the design of FIG. 8C is shown without the recesses 27 for comparison.

FIG. 8E shows a plot of the flux density in the air gap 34 of the electrical machine 20. The angle along the air gap 34 is plotted on the x-axis. The flux density is plotted on the y-axis. Here, the dashed line refers to the design shown in FIG. 8B. The solid line refers to the exemplary embodiment of the electrical machine 20 shown in FIG. 8A.

In FIG. 8F, the flux density in the air gap 34 of the electrical machine 20 is plotted broken down by harmonic components. On the x-axis, the order of the harmonic components of the magnetomotive force is plotted. On the y-axis, the flux density is plotted. The filled bars refer to the design shown in FIG. 8B. The empty bars refer to the exemplary embodiment shown in FIG. 8A. The fundamental wave is reduced by 76% compared to the case where the electrical machine 20 has no recesses 27. In addition, for the harmonic components of orders 6 and 8, the flux density is increased for the exemplary embodiment shown in FIG. 8A compared to the case where the electrical machine 20 has no recesses 27.

In FIG. 8G, the winding factor of the electrical machine 20 from FIG. 8A is plotted. For this purpose, the order of the harmonic component of the magnetomotive force is plotted on the x-axis. On the y-axis, the equivalent winding factor is plotted. Thus, for the harmonics of orders 6 and 8, there is a winding factor of well above 1, namely about 1.7. For the exemplary embodiment of FIG. 8A, the harmonic component of the magnetomotive force of order 6 or 8 can thus be used as a working wave for an efficient operation of the electrical machine 20.

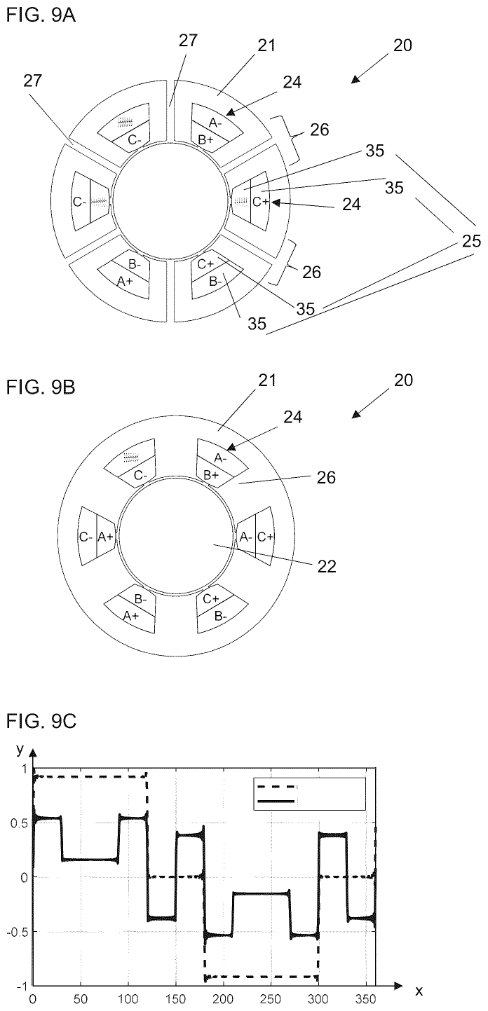

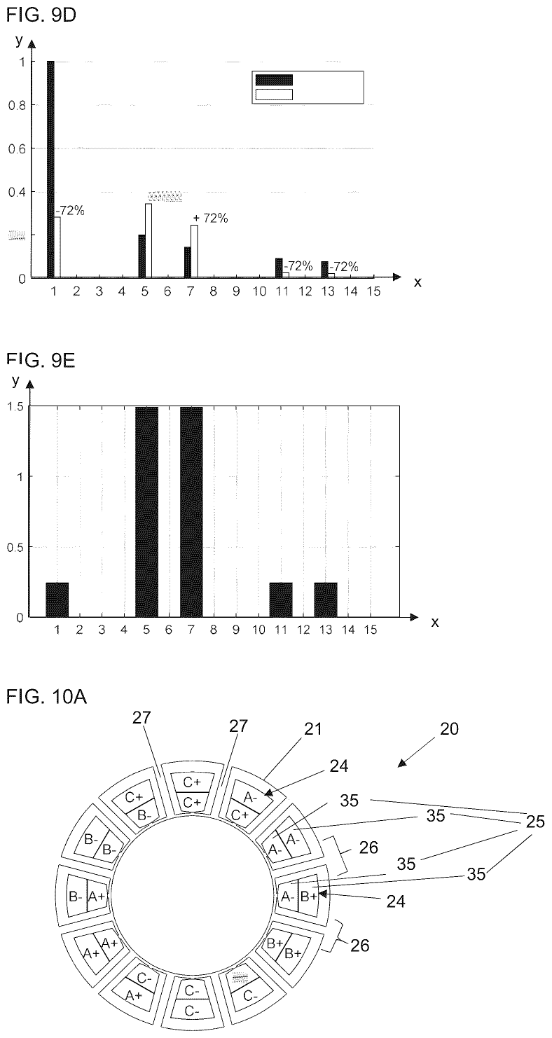

FIG. 9A shows a further exemplary embodiment of the electrical machine 20. In contrast to the exemplary embodiment shown in Figure TA, two components of the electrical winding are arranged in each slot 24, which are designed to be supplied with different phase currents. Thus, the electrical winding 25 is a 3-phase two-layer winding 25, with conductor portions 35 of two different coils 28 of the winding 25 being arranged in each slot 24. This means that conductor portions of two phases are arranged in each slot 24. In this arrangement, conductor portions 35 of the same phase are arranged in neighboring slots 24 in each case. For example, two conductor portions 35 of phase A+ are arranged in two neighboring slots 24. A recess 27 is arranged in each tooth 26.

For comparison, FIG. 9B shows the design from FIG. 9A without the recesses 27.

FIG. 9C shows a plot of the flux density in the air gap 34 of the electrical machine 20. On the x-axis, the angle along the air gap 34 is plotted. On the y-axis, the flux density is plotted. Here, the dashed line refers to the design shown in FIG. 9B. The solid line refers to the exemplary embodiment of the electrical machine 20 shown in FIG. 9A.

FIG. 9D shows a plot of the flux density in the air gap 34 of the electrical machine 20 broken down by harmonic components. On the x-axis, the order of the harmonic components of the magnetomotive force is plotted. The flux density is plotted on the y-axis. The filled bars refer to the design shown in FIG. 9B. The empty bars refer to the exemplary embodiment shown in FIG. 9A. The fundamental wave is reduced by 72% compared to the case where the electrical machine 20 has no recesses 27. In addition, for the harmonic components of orders 5 and 7, the flux density is increased for the exemplary embodiment shown in FIG. 9A compared to the case where the electrical machine 20 has no recesses 27.

FIG. 9E shows a plot of the winding factor of the electrical machine 20 from FIG. 9A. The order of the harmonic component of the magnetomotive force is plotted on the x-axis. On the y-axis, the equivalent winding factor is plotted. Thus, for the harmonics of orders 5 and 7, the winding factor is well above 1, namely about 1.5. For the exemplary embodiment of FIG. 9A, the harmonic component of the magnetomotive force of order 5 or 7 can thus be used as a working wave for an efficient operation of the electrical machine 20.

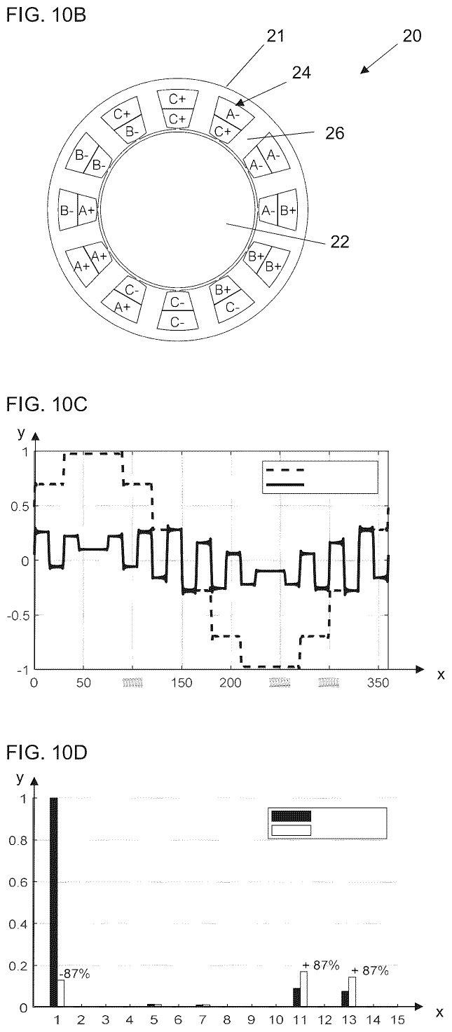

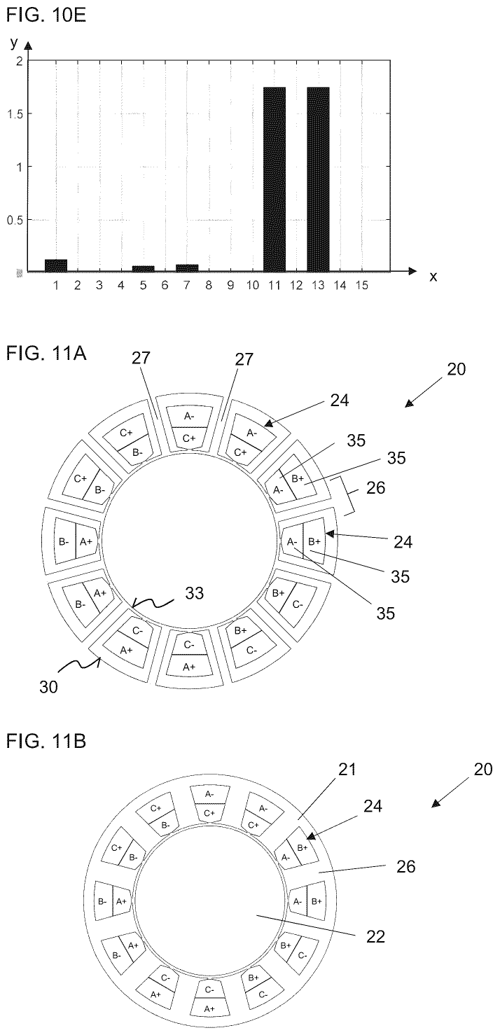

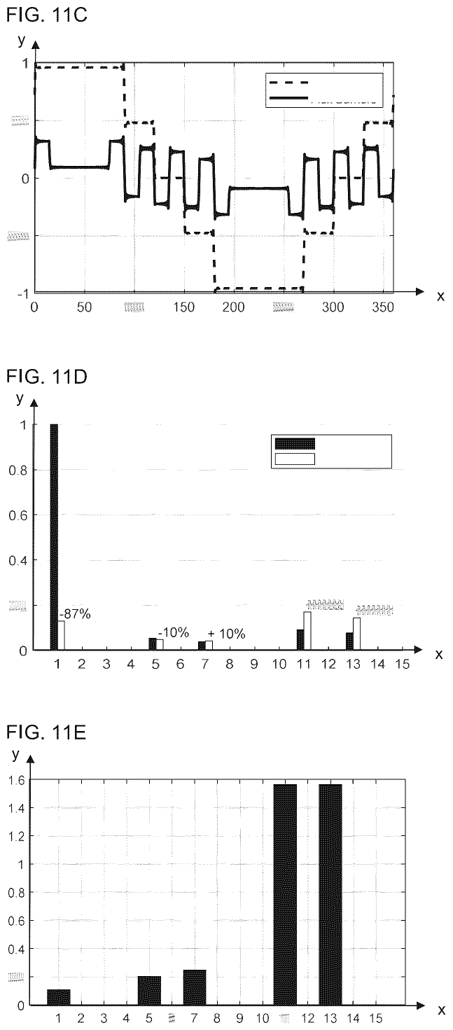

FIG. 10A shows a further exemplary embodiment of the electrical machine 20. Unlike the exemplary embodiment shown in FIG. 9A, the stator 21 has twelve slots 24 and twelve teeth 26. In each slot 24, there are arranged two components of the electrical winding 25 which are designed to be supplied with different phase currents. The electrical winding 25 is thus a 3-phase two-layer winding 25. The conductor portions 35 of one direction of a phase are distributed over three adjacent slots 24. For example, two conductor portions 35 of phase A+ are arranged in the same slot 24. One conductor portion 35 of phase A+ is arranged in each of the slots 24 adjacent thereto. Thus, two conductor portions 35 of the same phase are arranged offset by one slot 24 relative to other conductor portions 35 of the same phase. This applies to all phases. The stator 21 has a recess 27 in each tooth 26.

FIG. 10B shows the design of FIG. 10A without the recesses 27 for comparison.

FIG. 10C shows a plot of the flux density in the air gap 34 of the electrical machine 20. On the x-axis, the angle along the air gap 34 is plotted. On the y-axis, the flux density is plotted. Here, the dashed line refers to the design shown in FIG. 10B. The solid line refers to the exemplary embodiment of the electrical machine 20 shown in FIG. 10A.

FIG. 10D shows a plot of the flux density in the air gap 34 of the electrical machine 20 broken down by harmonic components. On the x-axis, the order of the harmonic components of the magnetomotive force is plotted. The flux density is plotted on the y-axis. The filled bars refer to the design shown in FIG. 10B. The empty bars refer to the exemplary embodiment shown in FIG. 10A. The fundamental wave is reduced by 87% compared to the case where the electrical machine 20 has no recesses 27. In addition, the harmonic components of orders 11 and 13 for the exemplary embodiment shown in FIG. 10A have an increased flux density compared to the case where electrical machine 20 has no recesses 27.

FIG. 10E shows a plot of the winding factor of the electrical machine 20 from FIG. 10A. The order of the harmonic component of the magnetomotive force is plotted on the x-axis. On the y-axis, the equivalent winding factor is plotted. Thus, for the harmonics of orders 11 and 13, the winding factor is well above 1, namely about 1.7. For the exemplary embodiment of FIG. 10A, the harmonic component of the magnetomotive force of orders 11 or 13 can thus be used as a working wave for an efficient operation of the electrical machine 20.

FIG. 11A shows a further exemplary embodiment of the electrical machine 20. Unlike the exemplary embodiment shown in FIG. 10A, the conductor portions 35 of one phase and one direction are distributed over four slots 24. This means, for example, that conductor portions 35 of phase A+ are arranged in four different slots 24. In each case, two conductor portions 35 of the same phase and direction are arranged in the slots 24 closer to the outer side 30 of the stator 21 than to the inner side 33 of the stator 21, and two conductor portions 35 of the same phase and direction are arranged so as to be closer to the inner side 33 of the stator 21 than to the outer side 30 of the stator 21. The stator 21 has a recess 27 in each tooth 26.

In FIG. 11B, the design of FIG. 11A is shown without the recesses 27 for comparison.

FIG. 11C shows a plot of the flux density in the air gap 34 of the electrical machine 20. On the x-axis, the angle along the air gap 34 is plotted. On the y-axis, the flux density is plotted. Here, the dashed line refers to the design shown in FIG. 11B. The solid line refers to the exemplary embodiment of the electrical machine 20 shown in FIG. 11A.

FIG. 11D shows a plot of the flux density in the air gap 34 of the electrical machine 20 broken down by harmonic components. The order of the harmonic components of the magnetomotive force is plotted on the x-axis. The flux density is plotted on the y-axis. The filled bars refer to the design shown in FIG. 11B. The empty bars refer to the exemplary embodiment shown in FIG. 11A. The fundamental wave is reduced by 87% compared to the case where the electrical machine 20 has no recesses 27. In addition, the harmonic components of orders 11 and 13 for the exemplary embodiment shown in FIG. 11A have an increased flux density compared to the case where electrical machine 20 has no recesses 27.

FIG. 11E shows a plot of the winding factor of the electrical machine 20 from FIG. 11A. The order of the harmonic component of the magnetomotive force is plotted on the x-axis. The equivalent winding factor is plotted on the y-axis. Thus, for the harmonic of the orders 11 and 13, the winding factor is significantly higher than 1, namely about 1.6. For the exemplary embodiment of FIG. 11A, the harmonic component of the magnetomotive force of order 11 or 13 can thus be used as a working wave for an efficient operation of the electrical machine 20.

### LIST OF REFERENCE SIGNS

20 Electrical machine
21 Stator
22 Rotor
23 Stator core
24 Slot
25 Electrical winding
26 Tooth
27 Recess
28 Coil
29 Non-magnetic material
30 Outer side
31 Rod-shaped electrical conductors
32 Short-circuit ring
33 Inner side
34 Air gap
35 Conductor portion
36 First side
37 Second side
r Radial direction

1. An electrical machine, comprising:
a stator; and
a rotor movable relative to the stator,
wherein:
the stator includes a stator core in which at least six slots are arranged;
the stator includes a distributed electrical winding which is at least partially arranged in the slots;
the stator includes at least six teeth;
one tooth of the stator is formed between two neighboring slots in each case;
at least three of the teeth comprise a recess which extends at least partially through the respective tooth; and
in operation of the electrical machine, a working wave of the magnetomotive force differs from a fundamental wave of the magnetic flux.

2. The electrical machine according to claim 1, wherein the electrical winding comprises coils which each are wound around at least two of the teeth.

3. The electrical machine according to claim 1, wherein the recesses are devoid of the electrical winding.

4. The electrical machine according to claim 1, wherein the recesses each extend in a radial direction, the radial directions each extending parallel to a radius in a cross-section through the stator and the radius extends through the respective tooth.

5. The electrical machine according to claim 4, wherein the recesses extend further along the respective radial direction than the neighboring slots.

6. The electrical machine according to claim 1, wherein a non-magnetic material is arranged in the recesses in each case.

7. The electrical machine according to claim 1, wherein the recesses are uniformly distributed along the circumference of the stator.

8. The electrical machine according to claim 1, wherein the recesses each adjoin at least an outer side of the stator.

9. The electrical machine according to claim 1, wherein each tooth comprises one of the recesses.

10. The electrical machine according to claim 1, wherein every other tooth along the circumference of the stator comprises one of the recesses.

11. The electrical machine according to claim 1, wherein the stator comprises at most as many recesses as slots.

12. The electrical machine according to claim 1, wherein the stator comprises more than six teeth.

13. The electrical machine according to claim 1, wherein at least two components of the electrical winding are arranged in each slot, which are designed to be supplied with different phase currents.

14. An electrical machine, comprising:
a stator; and
a rotor movable relative to the stator,
wherein:
the stator includes a stator core in which at least three slots are arranged;
the stator includes at least three teeth and at least three rod-shaped electrical conductors;
at least one of the conductors is arranged in the slots in each case;
one tooth of the stator is formed between two neighboring slots in each case;
at least three of the teeth comprise a recess which extends at least partially through the respective tooth; and
in operation of the electrical machine, a working wave of the magnetomotive force differs from a fundamental wave of the magnetic flux.

15. The electrical machine according to claim 14, wherein the three conductors are electrically short-circuited on a side of the stator.

16. A method for operating an electrical machine, the method including:
operating the electrical machine with a working wave of the magnetomotive force, the working wave differing from a fundamental wave of the magnetic flux,
wherein:
the electrical machine comprises a stator comprising a stator core in which at least six slots are arranged, a distributed electrical winding which is at least partially arranged in the slots, and at least six teeth;
the electrical machine comprises a rotor which is movable relative to the stator;
one tooth of the stator is formed between two neighboring slots in each case; and
at least three of the teeth comprise a recess which extends at least partially through the respective tooth.

17. The method according to claim 16, wherein a harmonic of the magnetomotive force is used as a working wave, said harmonic comprising an order equal to the number of slots plus 1 or the number of slots minus 1.

18. A method for operating an electrical machine, the method comprising:
operating the electrical machine with a working wave of the magnetomotive force, the working wave differing from a fundamental wave of the magnetic flux,
wherein:
the electrical machine comprises a stator comprising a stator core in which at least three slots are arranged, at least three teeth, and at least three rod-shaped electrical conductors;
the electrical machine comprises a rotor which is movable relative to the stator;
at least one of the conductors is arranged in the slots in each case;
one tooth of the stator is formed between two neighboring slots in each case; and
at least three of the teeth comprise a recess which extends at least partially through the respective tooth.
